(19) United States
(12) Patent Application Publication
(10) Pub. No.: US 2013/0026432 A1
(43) Pub. Date: Jan. 31, 2013

(54) Electric Snake Deterrent Fencing

(71) Applicant: Hillary Anne Horvat, Rochester Hills, MI (US)

(72) Inventor: Hillary Anne Horvat, Rochester Hills, MI (US)

(21) Appl. No.: 13/301,571

(22) Filed: Nov. 21, 2011

Related U.S. Application Data
(60) Provisional application No. 61/511,974, filed on Jul. 26, 2011.

(51) Int. Cl. A01M 29/24

(52) U.S. Cl. 256/10

(57) ABSTRACT

A snake deterrent system that offers a physical barrier and an electric current to deter snakes from navigating over the barrier. The units are easily assembled together by use of a hinge system and easily installed with legs that go into the ground. The fencing system can be attached to most electric fence controllers that are used for livestock, pets, or wildlife. Offering a measure of safety to deter venomous snakes from posing a threat to people, children, pets, and livestock.

### CROSS-REFERENCE TO RELATED APPLICATIONS

None

This Application Claims the benefit of provisional patent application U.S. 61/511,974 filed Jul. 26, 2011 by the present Inventor.

### FEDERALLY SPONSORED RESEARCH

None

### SEQUENCE LISTING

None

### BACKGROUND

There are frequent conflicts between humans and wildlife, especially dangerous venomous snakes People wishing to protect their yards, children, pets, and livestock from being bitten by venomous snakes have few options; since snakes can navigate obstacles.

This is a fencing system that can connect to standard electric fence controllers to create an effective deterrent to snakes and other small wildlife. Electric fencing currently consists of wire, rope, or ribbon that is attached to the electric fence controller. These electric fences are not effective against snakes, since the snakes can easily crawl under the wires. Current methods for discouraging snakes from entering a contained area to use deterrent pellets placed on the ground, or to spray vinegar on the ground. Snakes find the pellets/vinegar offensive and so do not go into the area. This fencing aims to create a barrier that will effectively deter snakes from climbing over into the contained area by use of a top electrified portion of the fencing. The bottom plastic portion will act as an insulator for the electric current, while providing a physical barrier. Animals are very sensitive to electric current used in electric fence controllers, and this electric field will act as an effective deterrent to snakes and a variety of other small wildlife species.

Fencing is solid plastic on the bottom portion with a metal top portion that may or may not have metal overhangs or metal spikes; slightly different versions with overhangs and spikes are necessary depending on the particular species of snake that model is designed to deter. The fencing units connect together with hinges on the ends of the fence that are metal on the top portion of the fencing and plastic on the bottom portion. The hinges will be attached together with a hinge pin 6 that is metal on the top and plastic on the bottom portion. This hinge will fit together snuggly so as to conduct the electric current from the metal portion of one fencing unit to the others. Hinge pins may have a metal overhang portion for the corner hinge pins.

At least one fencing unit per fence will have a hole going thru the top metal section so a wire can be put thru to connect the fencing to an electric fence controller, such as a Fi-shock poultry charger model #SS-600.

The fencing units will stick into the ground with metal or plastic legs attached to the bottom of the units. Legs will be in a upside down U shape with 90 degree angles or upside down W shape with 90 degree angles to give stability to the units.

Fencing units that need to cross sections of driveway, or walkways will be small plastic two sided ramps with a metal bar flat across the center and metal 14 and plastic 15 rising up at the sides with hinges 16 to attach easily to the hinges of the standard fencing units and continue the electric circuit. There will also be a strip of metal 17 attached to the center metal bar 13 that runs along the outer rim of the ramp section 12 that is facing the non contained area so small snakes will still be grounded when they come into contact with that portion of the fencing. These driveway/walkway units will enable those pathways to still be used by turning off the electric current so that taking down the entire fencing is not necessary.

As far as I know, no former method of deterring snakes from entering a contained area is able to combine a physical barrier with an electric fencing component to discourage the snakes from navigating over the barrier.

### SUMMARY

A new and more effective method of protecting a contained area from venomous snakes is by creating a solid physical barrier fence that is on the top portion able to conduct electric current from standard electric fencing controllers.

This fencing system has the advantage of being easy to assemble and install; with use of hinges that attach the fencing units together and legs that stick easily into the ground. It also deals with the problem of offering containment across walkways and driveways by use of special ramped units; so that all that needs to be done in order to use those paths is to turn off the electric current, and avoids the hassle of having to disassemble the fencing. It also will work well with most properly grounded electric fence controllers designed for use with livestock, pets, or wildlife.

### DRAWINGS

FIG. 1 displays an entire electric snake fence containing a house and its surrounding yard.

FIG. 2 displays how the electric fence controller is grounded, plugged in, and connected to the fencing.

FIG. 3 displays a cross section of the standard fencing units showcasing several different models of fencing designed to deter different species of snakes.

FIG. 4 displays the two types of hinge pins, they are have a plastic lower section and metal upper section. There are three different views of the corner hinge pin with the overhang.

FIG. 5 displays 2 views of the driveway/walkway units

FIG. 6 Shows a front view of two standard fencing units hinged together and with their legs installed in the ground.

FIG. 7 Shows several fencing units assembled together into a fence. With appropriate hinge pins above where they go into the hinges.

FIG. 8 Shows one standard fencing unit with a controller hole that has a bit of wire going through it. This wire will attach to the Electric fence controller.

### NUMBER KEY

1 Plastic lower section of standard fencing unit

2 Metal top section of standard fencing unit

3 Metal Overhang on standard fencing unit

4 Metal Spikes on standard fencing unit

5 Hinge

6 Hinge Pin

7 Corner Hinge Pin

8 Corner Hinge Pin overhang

9 Controller Hole

10 Legs

11 Driveway/Walkway Unit

12 Plastic Ramp for Driveway/walkway unit

13 Metal Bar on Driveway/walkway unit

14 Driveway/walkway unit metal rising up

15 Driveway/walkway unit plastic rising up

16 Driveway/walkway unit hinges

17 Strip of metal on Driveway/walkway unit ramp

18 Electric Fence Controller/Electric Fence Charger

19 Ground Pole

20 Wire

21 AC power outlet

### DETAILED DESCRIPTION

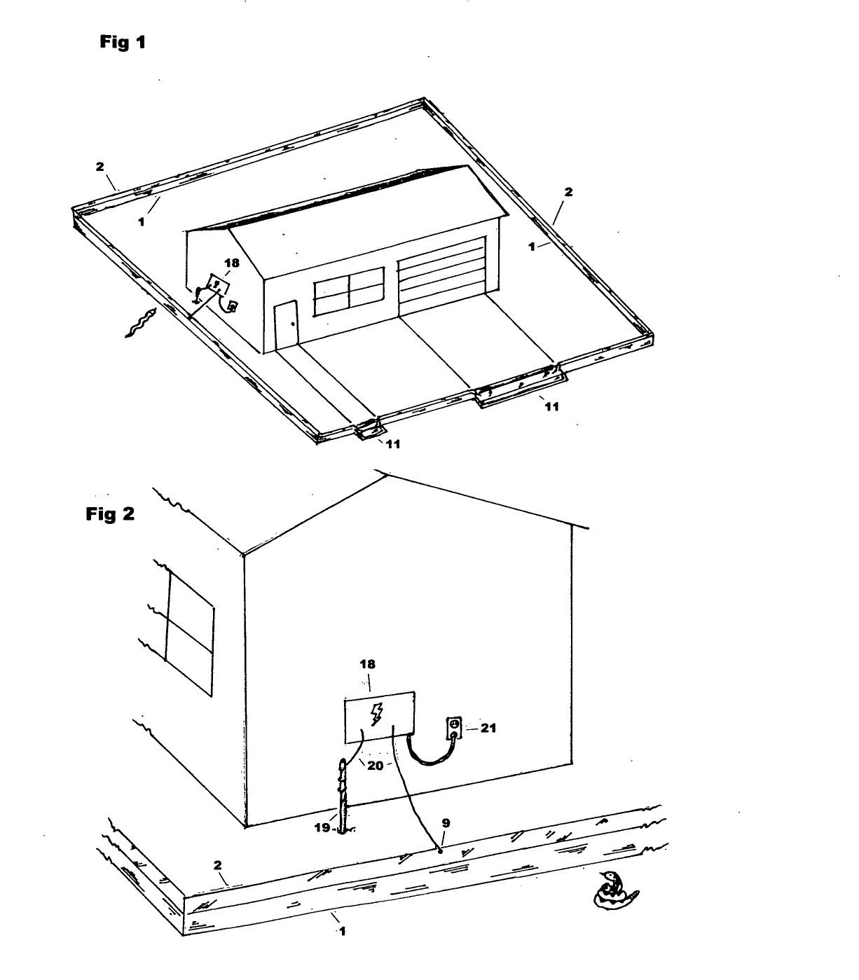

FIG. 1 is an example of a full electric snake fence surrounding a house and yard. There is a driveway/walkway unit 11 at the end of the driveway, and a driveway/walkway unit 11 at the end of the sidewalk. Standard fencing units surround the remainder of the yard. An electric fence controller 18 is plugged in, properly grounded, and attached with a wire 20 to the top metal portion 2 of the electric snake fence to conduct the electric current throughout the metal sections of the entire fence.

FIG. 2 shows a more detailed view of the electric fence controller 18, such as Fi-shock poultry charger model #SS-600, and how it connects to the fencing. The controller 18 is plugged into an AC outlet 21. There is a wire 20 running from the controller 18 to a ground pole 19. Another wire 20 runs from the charger to a hole 9 in the top metal portion 2 of the fencing, this wire conducts the electric current from the charger to the fence.

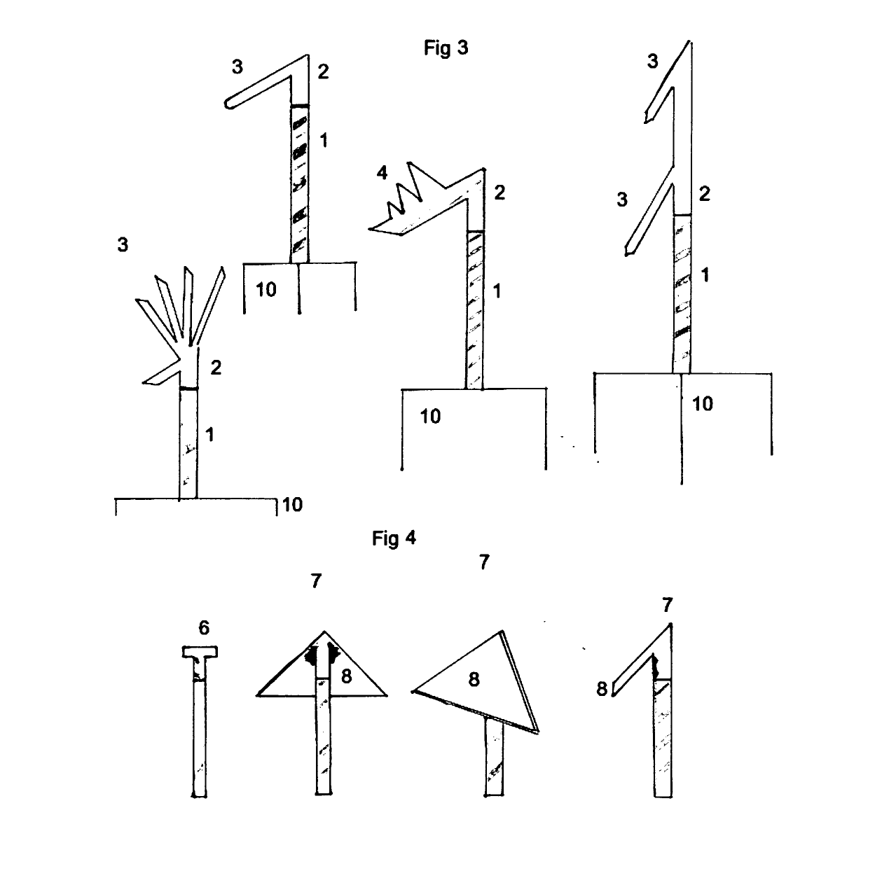

FIG. 3 is a showcase of four different models of fencing. The drawings are a cross section of the standard fencing units to show the different overhangs 3 and spikes 4 on the metal top portion 2 of the fencing for use on different models intended to deter different species of snakes For example black mambas can raise their bodies and heads up six feet in the air so several electrified overhangs and spikes will be needed to deter the snakes from climbing over the fencing. These drawings do not display the hinges that are on either side of the fencing units.

FIG. 4 is the fences hinge pins 6 that fit into the hinges 5 on the the fencing units to attach them to one another. Hinge Pins will fit snuggly into the hinges so as to continue the flow of electric current from one fencing unit to the next. The hinge pins 6 have a metal top portion and a plastic lower portion to correspond with the metal and plastic sections of the fencing units and to conduct or insulate the electric current. The first pin on the left is the standard hinge pin 6, and the other three are three different views of the corner hinge pin 7 with an overhang 8; a rear view, a front view, and a side view.

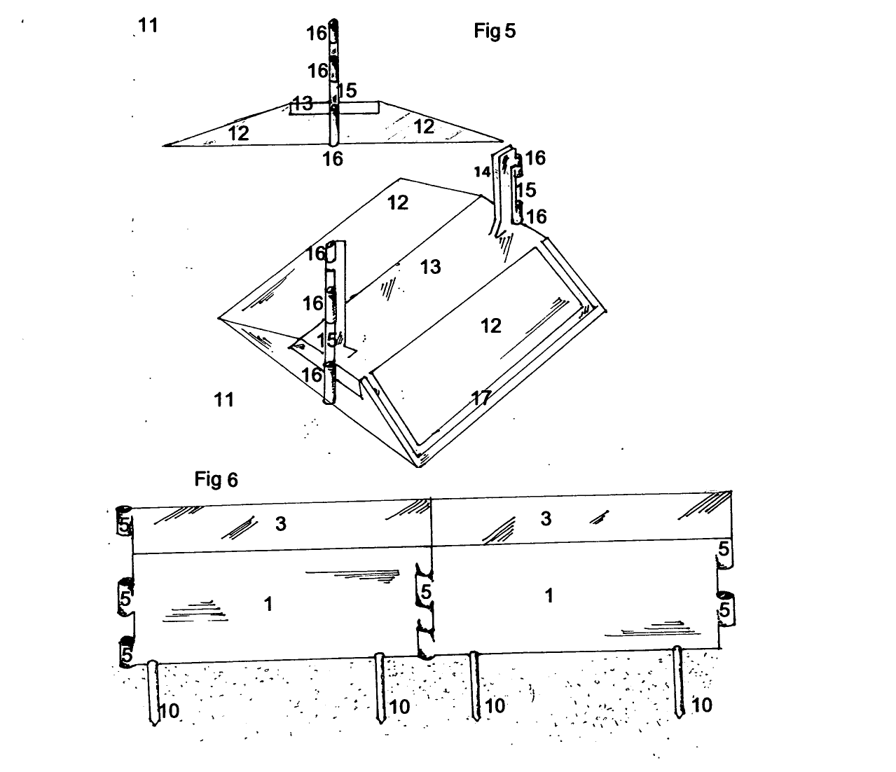

FIG. 5 shows the driveway/walkway units 11 from a side view in the top picture and a front/above view in the lower drawing. These units will have high plastic 15 and metal 14 end sections rising up from the ends that have hinges 16 to attach with a hinge pin to the standard fencing units. There is a metal bar 13 in the center of the two plastic ramps 12 that will conduct the electricity across the unit and will be attached to the metal section 14 that rises up high off the ends of the unit; to continue the electric circuit. There will be an electric metal strip 17 that is on the top section of the outside facing ramp that will be connected to the metal center bar. This strip 17 will be able to deter small snakes that would otherwise be able to crawl entirely onto the plastic ramp and no longer be grounded when they hit the center metal bar 13.

FIG. 6 is two standard fencing units attached together. The units have their legs 10 installed into the ground. The hinges 5 on either side can be clearly seen. Each side of a unit has both metal hinges on the top portion, and plastic hinges on the lower portion.

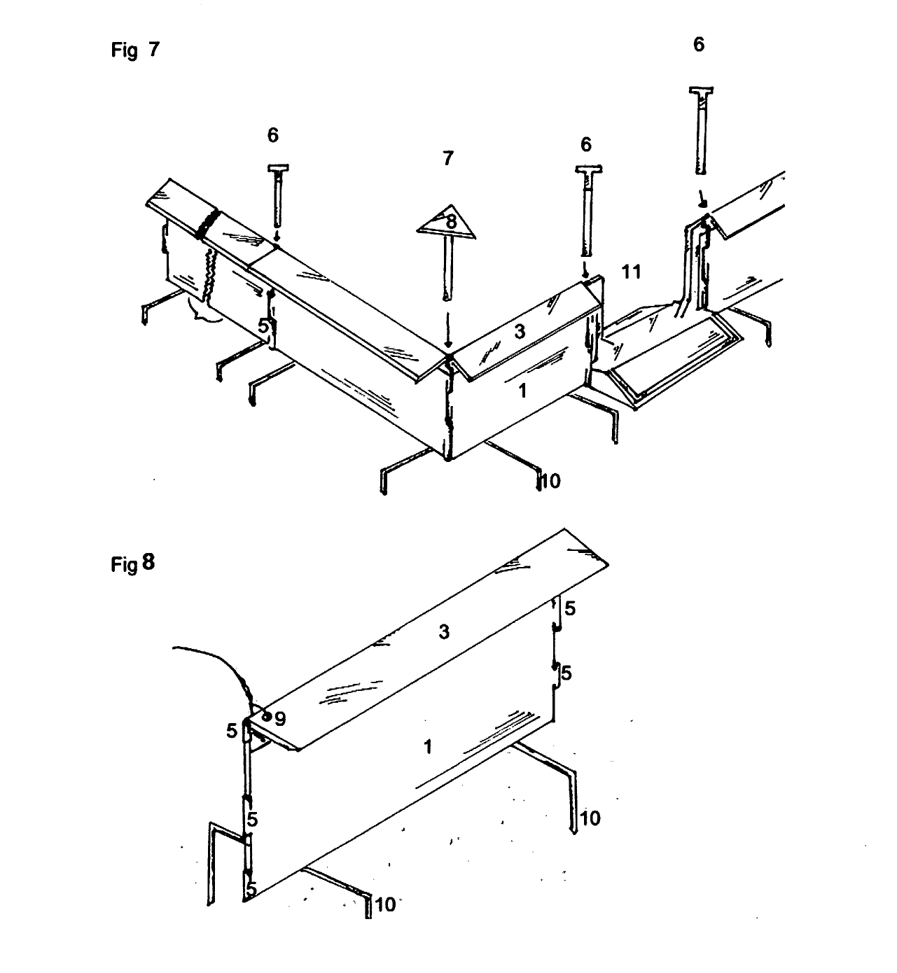

FIG. 7 is several standard fencing units and one driveway/walkway unit 11 connected together to make a portion of a fence. The hinge pins 6 are displayed above the hinges 5 that they are installed into so that the appropriate use of the corner hinge pin 7 can be seen. Electric current runs throughout the metal section of all connected fencing units.

FIG. 8 is a standard fencing unit that has a controller hole 9 in the left side of the top metal section and metal overhang section. There is a bit of wire going through the controller hole that would be connected to the electric fence controller to bring the electric charge to the entire fencing system.

### Operation

Fencing units are installed with the legs 10 and a small portion of the lower plastic section 1 securely in the ground; driveway/walkway units 11 sit flat directly on the ground. The units hinge together by use of the hinge pins. The unit with the controller hole is attached by use of a wire to an electric fence controller that is properly grounded. When the fence controller is turned on the electric current will run through the metal sections of all fencing units and hinge pins creating an effective deterrent for keeping snakes out of a fully contained area.

I claim:

1. An electric fence for deterring snakes, comprising:
an electric fence current source for providing an electric current;
a conducting portion for conducting the current; and
a non-conducting portion interposed between a selected surface and the conducting portion such that a snake is deterred from traversing between the selected surface and the conducting portion, the non-conducting portion having a first surface generally facing the selected surface and a generally opposing second surface.
wherein at least a portion of the conducting portion is at least partially embedded in the second surface.

2. The fence of claim 1, further comprising a third surface positioned at an acute angle from the second surface to form a ramp portion.

3. The fence of claim 2, further comprising a second conducting portion electrically connected to the conducting portion, wherein the conducting portion is elongated and the second conducting portion is elongated and positioned generally parallel to the conducting portion.

4. The fence of claim 3, wherein the second conducting portion is coupled to the third surface of the first ramp portion.

5. The fence of claim 4, further comprising a second ramp portion extending from an edge of the non-conducting portion and generally opposing the first ramp portion.

6. The fence of claim 1, wherein the selected surface is a driveway.

7. The fence of claim 1, further comprising a plurality of securing portions for piercing the selected surface and couple the non-conducting portion to the selected surface.

8. The fence of claim 7, wherein the selected surface is sod.
